(19) United States
(12) Patent Application Publication
(10) Pub. No.: US 2024/0112278 A1
(43) Pub. Date: Apr. 4, 2024

(54) ENHANCED INTAKE OF BANK BAI FILES

(71) Applicant: Level 3 Communications, LLC, Broomfield, CO (US)

(72) Inventor: Idilio MONCIVAIS-PINEDO, Broomfield, CO (US)

(73) Assignee: Level 3 Communications, LLC, Broomfield, CO (US)

(21) Appl. No.: 18/477,398

(22) Filed: Sep. 28, 2023

Related U.S. Application Data
(60) Provisional application No. 63/378,026, filed on Sep. 30, 2022.

(51) Int. Cl. G06Q 40/12

(52) U.S. Cl. CPC G06Q 40/12

(57) ABSTRACT

This disclosure describes systems, methods, and devices related to processing Bank Administration Institute (BAI) files. A method may include identifying, by at least one processor of an integration server, copies of BAI files indicative of payment information; importing, by the at least one processor, data from the BAI files into a staging table; parsing, by the at least one processor, the data in the staging table using a hierarchy defining a file level, a group level, an account level, and a transaction level to generate hierarchized data; normalizing, by the at least one processor, the hierarchized data into tables; and copying, by the at least one processor, differences between the hierarchized data and previous hierarchized data to a workflow associated with identifying payment amounts in the hierarchized data.

### CROSS-REFERENCE TO RELATED APPLICATION

This application is related to an claims priority under 35 U.S.C. § 119(e) from U.S. Patent Application No. 63/378,026, filed Sep. 30, 2022, titled “ENHANCED INTAKE OF BANK BAI FILES,” the entire content of which is incorporated herein by reference for all purposes.

### TECHNICAL FIELD

Embodiments of the present invention generally relate to systems and methods for processing Bank Administration Institute (BAI) files.

### BACKGROUND

When an electronic workflow payment system processes many payments from many customers using BAI files, the processing of the BAI files can be inefficient. In particular, it may be difficult to reconcile BAI data with System Applications and Products in Data Processing (SAP) to accurately determine the payment amounts in the BAI files.

### SUMMARY

A method for processing Bank Administration Institute (BAI) files may include: identifying, by at least one processor of an integration server, copies of BAI files indicative of payment information; importing, by the at least one processor, data from the BAI files into a staging table; parsing, by the at least one processor, the data in the staging table using a hierarchy defining a file level, a group level, an account level, and a transaction level to generate hierarchized data; normalizing, by the at least one processor, the hierarchized data into tables; and copying, by the at least one processor, differences between the hierarchized data and previous hierarchized data to a workflow associated with identifying payment amounts in the hierarchized data.

A system for processing Bank Administration Institute (BAI) files, the system including memory coupled to at least one processor of an integration server, the at least one processor able to: identify copies of BAI files indicative of payment information; import data from the BAI files into a staging table; parse the data in the staging table using a hierarchy defining a file level, a group level, an account level, and a transaction level to generate hierarchized data; normalize the hierarchized data into tables; and copy differences between the hierarchized data and previous hierarchized data to a workflow associated with identifying payment amounts in the hierarchized data.

A non-transitory computer-readable storage medium comprising instructions to cause at least one processor of a device for processing Bank Administration Institute (BAI) files, upon execution of the instructions by the at least one processor, to: identify copies of BAI files indicative of payment information; import data from the BAI files into a staging table; parse the data in the staging table using a hierarchy defining a file level, a group level, an account level, and a transaction level to generate hierarchized data; normalize the hierarchized data into tables; and copy differences between the hierarchized data and previous hierarchized data to a workflow associated with identifying payment amounts in the hierarchized data.

### BRIEF DESCRIPTION OF THE DRAWINGS

FIG. 1 illustrates an example system for processing Bank Administration Institute (BAI) files in accordance with one embodiment.

FIG. 2A shows a file structure for a BAI file in accordance with one embodiment.

FIG. 2B shows the file structure of FIG. 2A in accordance with one embodiment.

FIG. 2C shows the file structure of FIG. 2A in accordance with one embodiment.

FIG. 2D shows the file structure of FIG. 2A in accordance with one embodiment.

FIG. 2E shows the file structure of FIG. 2A in accordance with one embodiment.

FIG. 3 shows a BAI file hierarchy in accordance with one embodiment.

FIG. 4 is a flow for a process for processing BAI files in accordance with one embodiment.

FIG. 5 is a diagram illustrating an example of a computing system that may be used in implementing embodiments of the present disclosure.

### DETAILED DESCRIPTION

Aspects of the present disclosure involve systems, methods, and the like, for enhanced processing of Bank Administration Institute (BAI) files.

When an electronic payment system processes payments documented in BAI files from multiple customers using multiple banks, it may be difficult to reconcile the payment amounts from the BAI files when using SAP software. In particular, different banks used by different customers may have different bank reference numbers using different formats and in different locations of BAI files documenting transactions.

BAI files use a format in which there is a file name, a file header (e.g., using the string “01”), file trailer (e.g., using the string “99”), group header (e.g., using the string “02”), group trailer (e.g., using the string “98”), account header (e.g., using the string “03”), account trailer (e.g., using the string “49”), transaction data (e.g., using the string “16”), and extended account data (e.g., using the string “88”). Where the bank is indicated and how, and where the payment amount is indicated and how in a BAI record may vary, resulting in difficulty for an automated system to identify the bank, payment amount, and payer.

There is therefore a need for enhanced processing of BAI files.

In one or more embodiments, an electronic payment processing system may include an integration server to receive BAI files from banks. The integration server may identify headers, groups, accounts, and transaction data in the BAI files, and may store the identified data from the BAI files in databases for use in generating reports.

In one or more embodiments, using an enhanced interface of the integration server, the BAI files may be copied from a site using an extract, transform, and load (ETL) tool. For example, a SSIS ETL of SQL software may process the copies of the BAI files, importing the BAI data into a staging table “as is.” The enhanced BAI processing may parse BAI data using a BAI hierarchy, and the hierarchized data may be normalized into tables. The resulting tables may use a relational data model for BAI file, group, account, and transaction, and a flattened table with BAI data also may be generated. The daily processing deltas may be copied into a database.

In one or more embodiments, a BASH script may be used for the BAI file acquisition. The BASH script may capture the current day's date into memory, and may connect to the site having he BAI files by using a secure file transfer protocol (sFTP). After connection to the site is successful, the BASH script may exchange SSL certificates to authenticate. Once authenticated, the BASH script copies files that match the date pattern YYYY-MM-DD. When connection is not successful, the BASH script waits and tries again until connection is successful. After the copy BAI file task is complete, the connection may close. The BASH scrip may save the copied BAI files to a folder in an ETL server for processing, and may copy the transferred files to a folder. The file transfer activity may be written to a sFTP log file, and the BASH script may write the BAI file copy tasks to a log file.

In one or more embodiments, a BAI file loop container may process the BAI files in a set directory path, process each BAI file, move a processed file to an archive folder, and log the processed file into an audit table.

In one or more embodiments, for each BAI file, he BAI file loop container may read the BAI text file and separate its columns, counting imported lines as rows. The BAI file loop container may assign an internal identifier to each line as a serial number, and tag each row with the file name and imported date-time stamp. The BAI file loop container may write all file rows to a staging table.

In one or more embodiments, the hierarchy builder for BAI files integration may define the file level hierarchy by using the identifiers of the file header (01) and trailer (99) as the floor and ceiling, and may assign a “file parent identifier” key to all records between the floor and ceiling. To define the group level hierarchy, the hierarchy builder may use the identifiers of the group header (02) and trailer (98) as the floor and ceiling, and may assign a “group parent identifier” key to all records between the floor and ceiling. To define the account level hierarchy, the hierarchy builder may use the identifiers of the account header (03) and trailer (49) as the floor and ceiling, and may assign an “account parent identifier” key to all extended data (88s) records between the floor and ceiling. To define the transaction level hierarchy, the hierarchy builder may use the identifiers of the transaction (16) as the header and the next transaction, or account trailer (49) as the floor and ceiling, and may assign a “transaction parent identifier” key to all extended transaction data (88s) records between the floor and ceiling.

In one or more embodiments, to build the normalized tables, for the file level, the system may use the built-in hierarchy to separate file level records, and may use the BAI specification to map columns from the text file into fields from the normalized table. For the group level, the system may use the built-in hierarchy to separate group level records, and may use the BAI specification to map columns from the text file into fields from the normalized table. For the account level, the system may use the built-in hierarchy to separate account level records, and may use the BAI specification to map columns from the text file into fields from the normalized table. For the transaction level, the system may use the built-in hierarchy to separate transaction level records, and may use the BAI specification to map columns from the text file into fields from the normalized table. There may be multiple rules to extract a “bank reference number” from the extended data rows (88).

In one or more embodiments, exporting BAI file data into a database may be for daily deltas. BAI files may be filtered for new records for inserts and changed records for updates. The tables that may be copied in addition to the normalized tables may include a BAI file table, a BAI flattened table, a BAI hierarchy table, and a BAI ETL audit control table. Additional CDW and EBS tables may be integrated into the database as well for analysis of cash receipts and transaction details.

The above descriptions are for purposes of illustration and are not meant to be limiting. Numerous other examples, configurations, processes, etc., may exist, some of which are described in greater detail below. Example embodiments will now be described with reference to the accompanying figures.

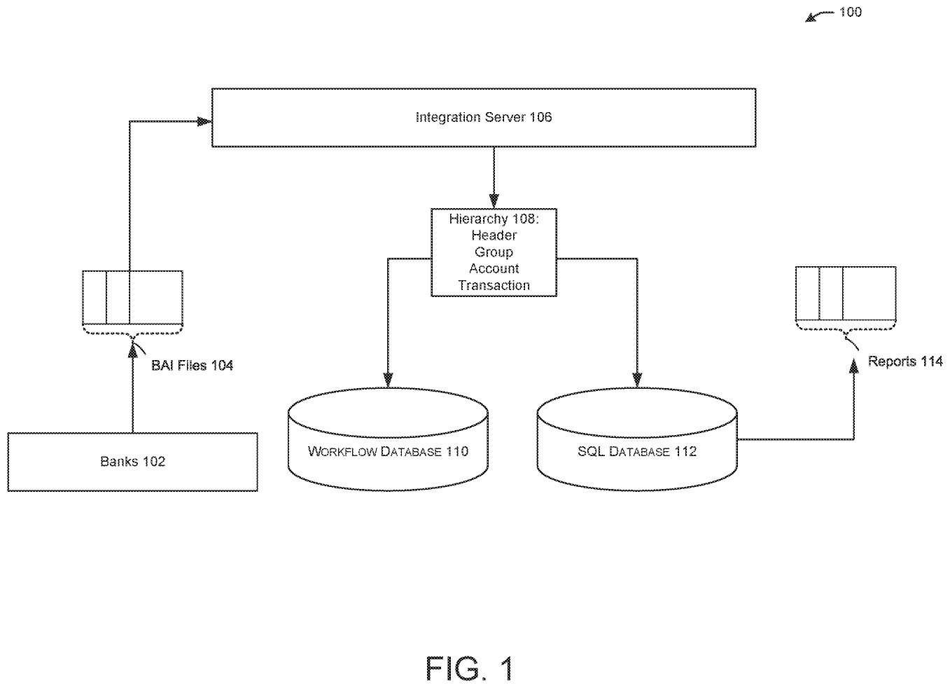

FIG. 1 illustrates an example system 100 for processing Bank Administration Institute (BAI) files in accordance with one embodiment.

Referring to FIG. 1, banks 102 may provide BAI files 104 showing bank transactions, which may be retrieved by an integration server 106. The integration server 106 may parse the BAI files 104 to generate a hierarchy 108 in which each BAI file may be organized by a header, a group, an account, and a transaction, using a relational data model. The hierarchy 108 may be normalized into tables and may be provided to a workflow database 110 (e.g., into which daily deltas of the hierarchized data may be copied) and to a SQL database 112, which may generate reports 114 using the BAI data.

In one or more embodiments, the integration server 106 may use a BASH script to capture the current day's date in the format of YYYY-MM-DD. Using a secure sFTP connection (e.g., to a site hosting the BAI files 104), the integration server 106 may copy the BAI files 104, and may log file transfer activity and copy tasks.

In one or more embodiments, the integration server 106 may read a BAI text file of the BAI files 104 and separate its columns, count the lines as rows, assign an internal identifier to each line, tag each row with the file name and date-time stamp, and write all rows to a staging table. To generate the file level hierarchy, the hierarchy builder of the integration server 106 may identify the file header identifiers 01 and trailers 99, and assign a file parent identifier key to all records between a file header identifier 01 and trailer 99. To generate the group level hierarchy, the hierarchy builder of the integration server 106 may identify the group header identifiers 02 and trailers 98, and assign a group parent identifier key to all records between a file group identifier 02 and trailer 98. To generate the account level hierarchy, the hierarchy builder of the integration server 106 may identify the account header identifiers 03 and trailers 49, and assign an account parent identifier key to all extended data (88s) records between an account header identifier 01 and trailer 49. To generate the transaction level hierarchy, the hierarchy builder of the integration server 106 may identify the transaction header identifiers 16 and the next transaction 16 or account trailer 49, and assign a transaction parent identifier key to all records between a transaction header identifier 16 and the next transaction 16 or account trailer 49.

In one or more embodiments, to generate the normalized tables, the integration server 106 may, for the file level, use the hierarchy 108 to separate file level records and map columns from the BAI text file into fields from the normalized table. For the group level, the integration server 106 may use the hierarchy 108 to separate group level records and map columns from the BAI text file into fields from the normalized table. For the account level, the integration server 106 may use the hierarchy 108 to separate account level records and map columns from the BAI text file into fields from the normalized table. For the transaction level, the integration server 106 may use the hierarchy 108 to separate transaction level records and map columns from the BAI text file into fields from the normalized table. A set of rules may be implemented to extract a bank reference number from the extended data rows (88).

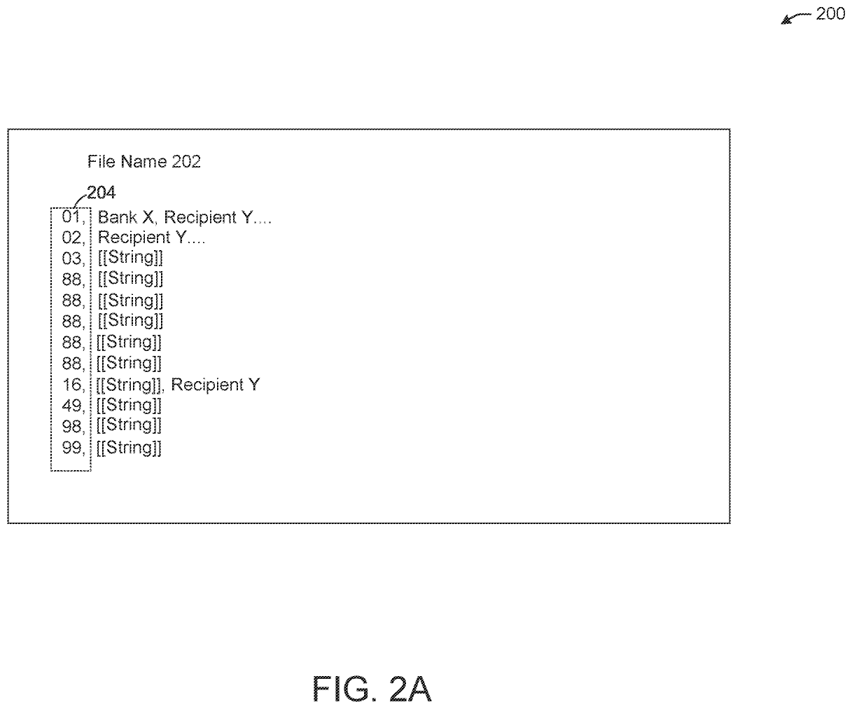

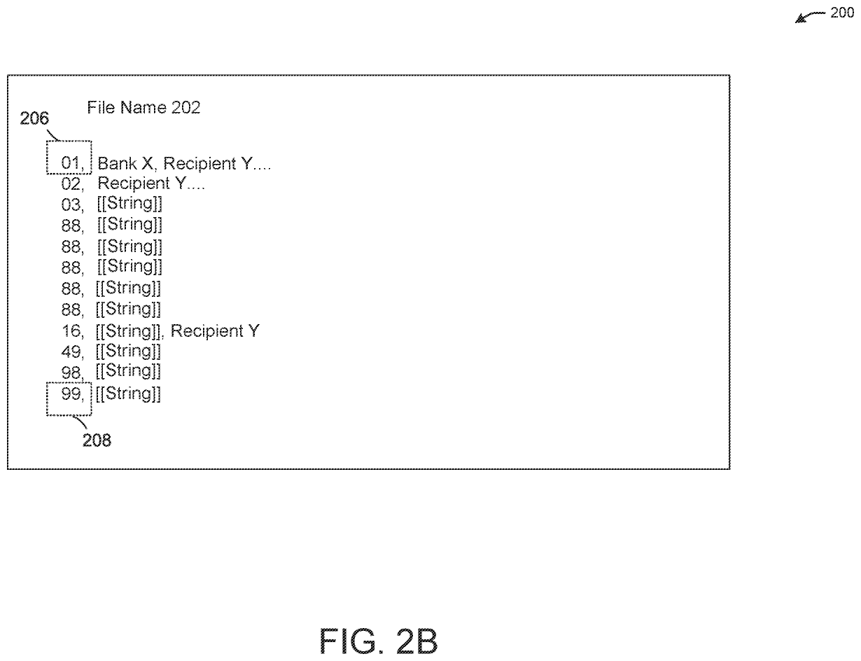

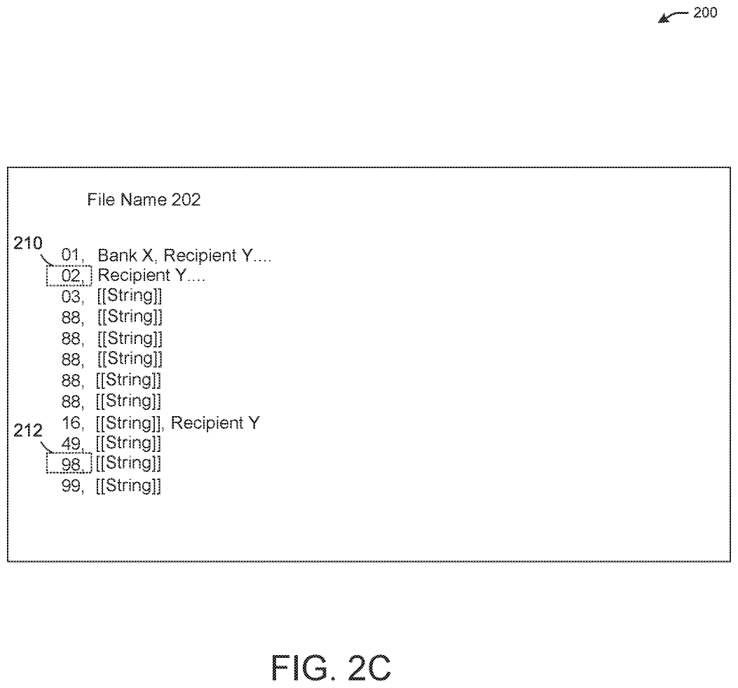

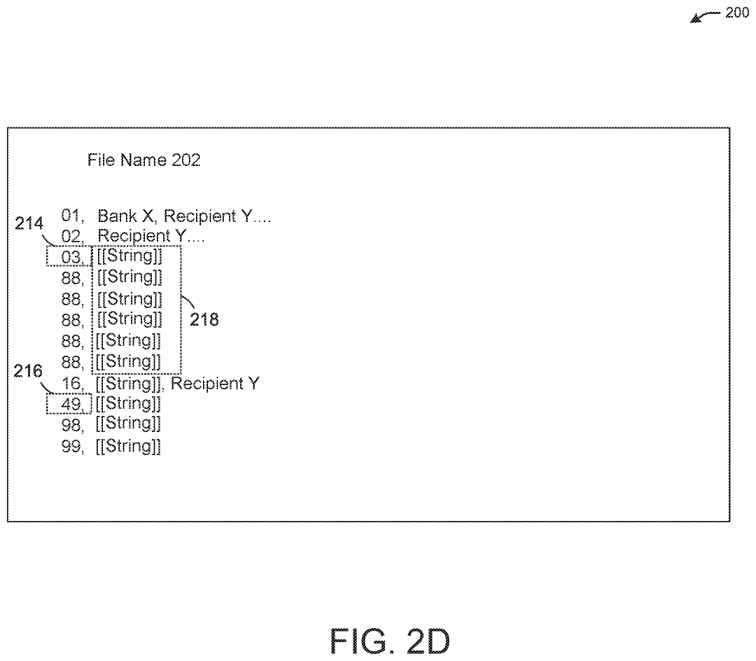

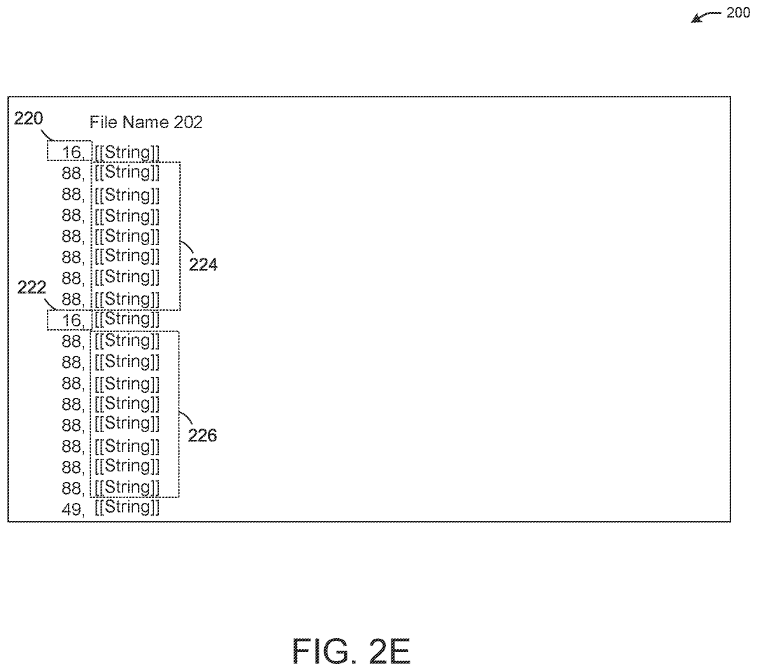

FIG. 2A shows a file structure for a BAI file 200 in accordance with one embodiment.

Referring to FIG. 2, the BAI file 200 may be one of the BAI files 104 of FIG. 1. As shown, the BAI file 200 may have a file name 202 and a record type 204. The record type 204 may include identifiers such as 01, 02, 03, 88, 16, 49, 98, and 99, which may be used to generate the hierarchy 108 of FIG. 1.

FIG. 2B shows the file structure of FIG. 2A in accordance with one embodiment.

Referring to FIG. 2B, the BAI file 200 of FIG. 2A may be processed by the hierarchy 108 of FIG. 1 to identify a file header 206 (e.g., having the 01 identifier) and a file trailer 208 (e.g., having the 99 identifier). The file header 206 and the file trailer 208 represent the file level of the hierarchy 108 of FIG. 1.

FIG. 2C shows the file structure of FIG. 2A in accordance with one embodiment.

Referring to FIG. 2C, the BAI file 200 of FIG. 2A may be processed by the hierarchy 108 of FIG. 1 to identify a group header 210 (e.g., having the 02 identifier) and a group trailer 212 (e.g., having the 98 identifier) within the file level of FIG. 2A. The group header 210 and the group trailer 212 represent the group level of the hierarchy 108 of FIG. 1.

FIG. 2D shows the file structure of FIG. 2A in accordance with one embodiment.

Referring to FIG. 2D, the BAI file 200 of FIG. 2A may be processed by the hierarchy 108 of FIG. 1 to identify an account header 214 (e.g., having the 03 identifier) and an account trailer 216 (e.g., having the 49 identifier) within the file level of FIG. 2A and the group level of FIG. 2B. Extended account data 218 (e.g., having the 88 identifier) may be identified between the account header 214 and the account trailer 216. The account header 214 and the account trailer 216 represent the account level of the hierarchy 108 of FIG. 1.

FIG. 2E shows the file structure of FIG. 2A in accordance with one embodiment.

Referring to FIG. 2E, the BAI file 200 of FIG. 2A may be processed by the hierarchy 108 of FIG. 1 to identify transaction 220 and transaction 222 (e.g., having the 16 identifier), extended transaction data 224 (e.g., having the 88 identifier, and between the respective transactions 220 and 222), and extended transaction data 226 (e.g., having the 88 identifier, and between the transaction 222 and the account trailer of FIG. 2D having the 49 identifier). The transactions 220 and 222, and the extended transaction data 224 and 226, represent the transaction level of the hierarchy 108 of FIG. 1.

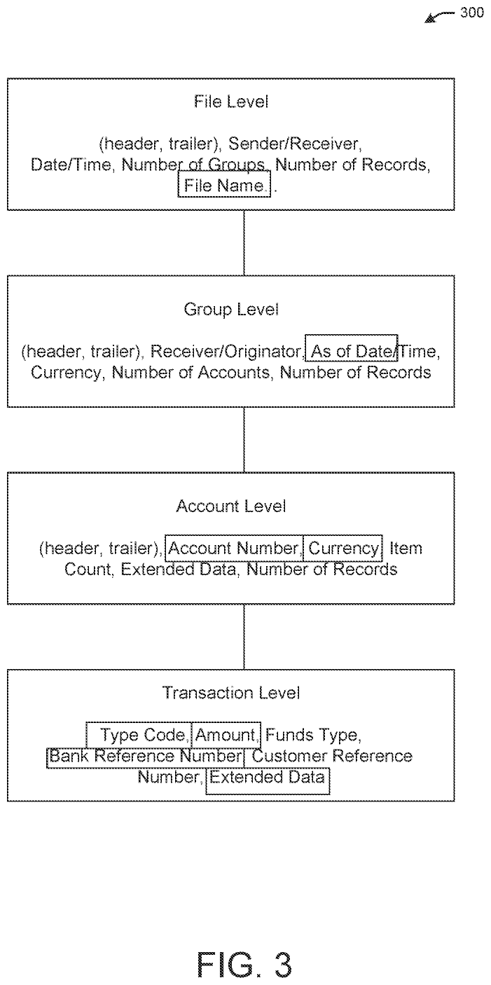

FIG. 3 shows a BAI file hierarchy 300 in accordance with one embodiment.

Referring to FIG. 3, the hierarchy 300 may include a file level, a group level, an account level, and a transaction level as identified in FIGS. 2A-2D. Using the hierarchy 108 of FIG. 1, the BAI data (e.g., of the BAI file 200 of FIGS. 2A-2D) may be parsed and then normalized into tables that may use a relational data model for the file level, group level, account level, and transaction level as shown.

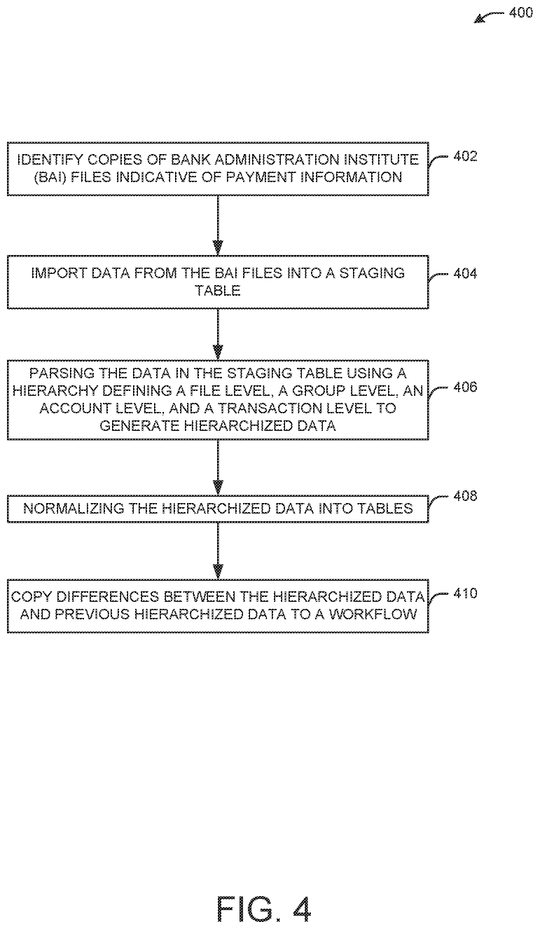

FIG. 4 is a flow for a process 400 for processing BAI files in accordance with one embodiment.

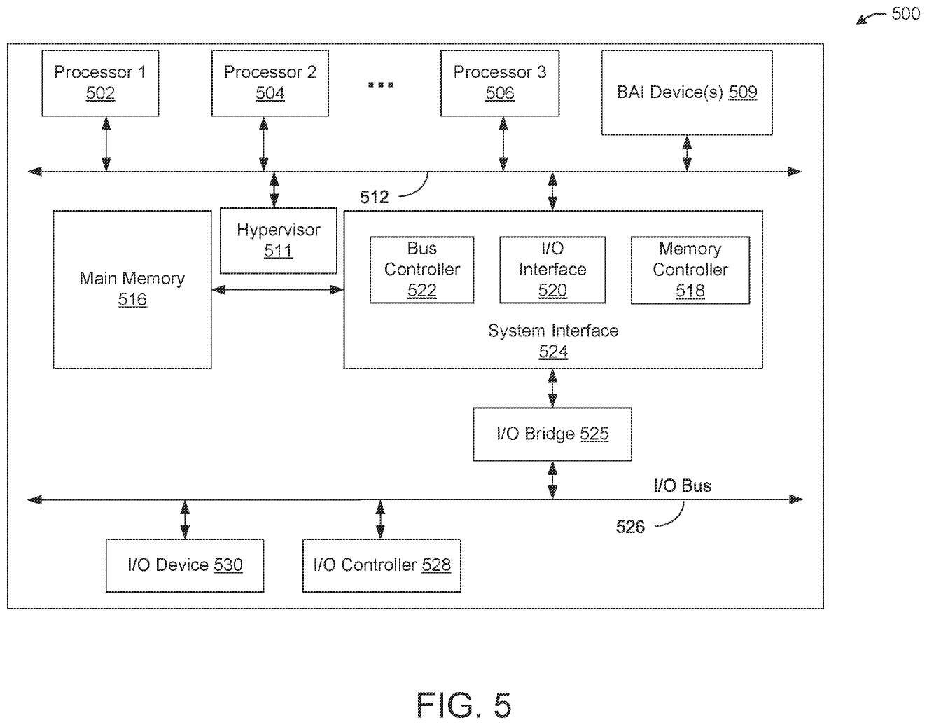

At block 402, a device (or system e.g., the integration server 106 of FIG. 1, the BAI devices 509 of FIG. 5) may identify copies of BAI files (e.g., the BAI files 104 of FIG. 1) indicative of payment information.

At block 404, the device may import data from the BAI files “as is” into a staging table.

At block 406, the device may parse the BAI data in the staging table using a hierarchy (e.g., the hierarchy 108 of FIG. 1) defining, for BAI files, file levels, group levels, account levels, and transaction levels for each BAI file.

At block 408, the device may normalize the hierarchized data into tables.

At block 410, the device may copy differences (e.g., daily deltas) between the hierarchized data and previous hierarchized data to a workflow for identifying bank reference identifiers and payment amounts.

It is understood that the above descriptions are for purposes of illustration and are not meant to be limiting.

FIG. 5 is a block diagram illustrating an example of a computing device or computer system 500 which may be used in implementing the embodiments of the components of the network disclosed above. For example, the computing system 500 of FIG. 5 may represent at least a portion of the system 100 shown in FIG. 1, as discussed above. The computer system (system) includes one or more processors 502-506, one or more BAI devices 509 (e.g., representing the integration server 106 of FIG. 1), and a hypervisor 511 (e.g., to instantiate and run virtual machines). Processors 502-506 may include one or more internal levels of cache (not shown) and a bus controller 522 or bus interface unit to direct interaction with the processor bus 512. Processor bus 512, also known as the host bus or the front side bus, may be used to couple the processors 502-506 with the system interface 524. System interface 524 may be connected to the processor bus 512 to interface other components of the system 500 with the processor bus 512. For example, system interface 524 may include a memory controller 518 for interfacing a main memory 516 with the processor bus 512. The main memory 516 typically includes one or more memory cards and a control circuit (not shown). System interface 524 may also include an input/output (I/O) interface 520 to interface one or more I/O bridges 525 or I/O devices with the processor bus 512. One or more I/O controllers and/or I/O devices may be connected with the I/O bus 526, such as I/O controller 528 and I/O device 530, as illustrated.

I/O device 530 may also include an input device (not shown), such as an alphanumeric input device, including alphanumeric and other keys for communicating information and/or command selections to the processors 502-506. Another type of user input device includes cursor control, such as a mouse, a trackball, or cursor direction keys for communicating direction information and command selections to the processors 502-506 and for controlling cursor movement on the display device.

System 500 may include a dynamic storage device, referred to as main memory 516, or a random access memory (RAM) or other computer-readable devices coupled to the processor bus 512 for storing information and instructions to be executed by the processors 502-506. Main memory 516 also may be used for storing temporary variables or other intermediate information during execution of instructions by the processors 502-506. System 500 may include a read only memory (ROM) and/or other static storage device coupled to the processor bus 512 for storing static information and instructions for the processors 502-506. The system outlined in FIG. 5 is but one possible example of a computer system that may employ or be configured in accordance with aspects of the present disclosure.

According to one embodiment, the above techniques may be performed by computer system 500 in response to processor 504 executing one or more sequences of one or more instructions contained in main memory 516. These instructions may be read into main memory 516 from another machine-readable medium, such as a storage device. Execution of the sequences of instructions contained in main memory 516 may cause processors 502-506 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 506 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 516, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed:

1. A method for processing Bank Administration Institute (BAI) files, the method comprising:
identifying, by at least one processor of an integration server, copies of BAI files indicative of customer payment information;
importing, by the at least one processor, data from the BAI files into a staging table;
parsing, by the at least one processor, the data in the staging table using a hierarchy defining a file level, a group level, an account level, and a transaction level to generate hierarchized data;
normalizing, by the at least one processor, the hierarchized data into tables; and
copying, by the at least one processor, differences between the hierarchized data and previous hierarchized data to a workflow associated with identifying payment amounts in the hierarchized data.

2. The method of claim 1, wherein generating the hierarchized data comprises:
identifying, in a BAI file of the BAI files, a 01 file header and a 99 file trailer for the file level;
identifying, in the BAI file, for the group level, a 02 group header and a 98 group trailer in between the 01 file header and the 99 file trailer;
identifying, in the BAI file, for the account level, a 03 account header and a 49 account trailer, plus 88 extended data, in between the 02 group header and the 98 group trailer; and
identifying, in the BAI file, for the transaction level, one or more transactions using a 16 transaction header, plus 88 extended data, in between the 03 account header and the 49 account trailer.

3. The method of claim 2, wherein generating the hierarchized data comprises:
identifying, in the BAI file, in between the 03 account header and the 49 account trailer, extended account data using a 88 identifier.

4. The method of claim 2, wherein generating the hierarchized data comprises:
identifying, in the BAI file, in between the 16 transaction header of a first transaction and the 16 transaction header of a second transaction or the 49 account trailer, extended transaction data using a 88 identifier.

5. The method of claim 4, further comprising:
extracting, using a set of rules, a bank reference number from the extended transaction data.

6. The method of claim 5, wherein extracting the bank reference number from the extended transaction data is based on identifying rows of the tables using the 88 identifier.

7. The method of claim 5, further comprising:
sending the bank reference number to the workflow.

8. A system for processing Bank Administration Institute (BAI) files, the system comprising memory coupled to at least one processor of an integration server, the at least one processor configured to:
identify copies of BAI files indicative of customer payment information;
import data from the BAI files into a staging table;
parse the data in the staging table using a hierarchy defining a file level, a group level, an account level, and a transaction level to generate hierarchized data;
normalize the hierarchized data into tables; and
copy differences between the hierarchized data and previous hierarchized data to a workflow associated with identifying payment amounts in the hierarchized data.

9. The system of claim 8, wherein to generate the hierarchized data comprises to:
identify, in a BAI file of the BAI files, a 01 file header and a 99 file trailer for the file level;
identify, in the BAI file, for the group level, a 02 group header and a 98 group trailer in between the 01 file header and the 99 file trailer;
identify, in the BAI file, for the account level, a 03 account header and a 49 account trailer, plus 88 extended data, in between the 02 group header and the 98 group trailer; and
identify, in the BAI file, for the transaction level, one or more transactions using a 16 transaction header, plus 88 extended data, in between the 03 account header and the 49 account trailer.

10. The system of claim 9, wherein to generate the hierarchized data comprises:
identify, in the BAI file, in between the 03 account header and the 49 account trailer, extended account data using a 88 identifier.

11. The system of claim 9, wherein to generate the hierarchized data comprises:
identify, in the BAI file, in between the 16 transaction header of a first transaction and the 16 transaction header of a second transaction or the 49 account trailer, extended transaction data using a 88 identifier.

12. The system of claim 11, wherein the at least one processor is further configured to:
extract, using a set of rules, a bank reference number from the extended transaction data.

13. The system of claim 12, wherein to extract the bank reference number from the extended transaction data is based on identifying rows of the tables using the 88 identifier.

14. The system of claim 12, wherein the at least one processor is further configured to:
send the bank reference number to the workflow.

15. A non-transitory computer-readable storage medium comprising instructions to cause at least one processor of a device for processing Bank Administration Institute (BAI) files, upon execution of the instructions by the at least one processor, to:
identify copies of BAI files indicative of customer payment information;
import data from the BAI files into a staging table;
parse the data in the staging table using a hierarchy defining a file level, a group level, an account level, and a transaction level to generate hierarchized data;
normalize the hierarchized data into tables; and
copy differences between the hierarchized data and previous hierarchized data to a workflow associated with identifying payment amounts in the hierarchized data.

16. The non-transitory computer-readable storage medium of claim 15, wherein to generate the hierarchized data comprises to:
identify, in a BAI file of the BAI files, a 01 file header and a 99 file trailer for the file level;
identify, in the BAI file, for the group level, a 02 group header and a 98 group trailer in between the 01 file header and the 99 file trailer;
identify, in the BAI file, for the account level, a 03 account header and a 49 account trailer, plus 88 extended data, in between the 02 group header and the 98 group trailer; and
identify, in the BAI file, for the transaction level, one or more transactions using a 16 transaction header, plus 88 extended data, in between the 03 account header and the 49 account trailer.

17. The non-transitory computer-readable storage medium of claim 16, wherein to generate the hierarchized data comprises:
identify, in the BAI file, in between the 03 account header and the 49 account trailer, extended account data using a 88 identifier.

18. The non-transitory computer-readable storage medium of claim 16, wherein to generate the hierarchized data comprises:
identify, in the BAI file, in between the 16 transaction header of a first transaction and the 16 transaction header of a second transaction or the 49 account trailer, extended transaction data using a 88 identifier.

19. The non-transitory computer-readable storage medium of claim 18, wherein the at least one processor is further configured to:
extract, using a set of rules, a bank reference number from the extended transaction data.

20. The non-transitory computer-readable storage medium of claim 19, wherein to extract the bank reference number from the extended transaction data is based on identifying rows of the tables using the 88 identifier.
